(19) United States
(12) Patent Application Publication
(10) Pub. No.: US 2023/0104553 A1
(43) Pub. Date: Apr. 6, 2023

(54) METHOD AND SYSTEM FOR PREDICTING MEMBERSHIP WITHDRAWAL

(71) Applicant: LINE PAY CORPORATION, Tokyo (JP)

(72) Inventors: Woong Kyu LEE, Seongnam-si (KR); Woosuk KIM, Seongnam-si (KR)

(73) Assignee: LINE PAY CORPORATION, Tokyo (JP)

(21) Appl. No.: 17/958,726

(22) Filed: Oct. 3, 2022

(30) Foreign Application Priority Data
Oct. 5, 2021 (KR) 10-2021-0131558

(51) Int. Cl. G06Q 30/02; G06N 20/20

(52) U.S. Cl. CPC G06Q 30/0202; G06N 20/20

(57) ABSTRACT

A method for predicting user withdrawal from a payment service is provided, which is performed by one or more processors and includes obtaining, from a memory, member information associated with one or more members, determining, by using a plurality of membership withdrawal prediction machine learning models, a plurality of withdrawal predictions for the one or more members based on the member information associated with the one or more members, and determining a final withdrawal prediction for the one or more members based on the determined plurality of withdrawal predictions.

### CROSS-REFERENCE TO RELATED APPLICATION

This application claims priority to Korean Patent Application No. 10-2021-0131558, filed in the Korean Intellectual Property Office on Oct. 5, 2021, the entire contents of which are hereby incorporated by reference.

### BACKGROUND

### Technical Field

The present disclosure relates to a method and a system for predicting membership withdrawal, and specifically, to a method and an apparatus for obtaining member information associated with members, predicting a plurality likelihoods of withdrawals by using a plurality of membership withdrawal prediction models, and integrating the prediction model results to make a synthesized withdrawal prediction for the members.

### Description of Related Art

With the proliferation of mobile devices such as smartphones and the development of the Internet, monetary payment applications have become widely used on mobile devices. Consumers can easily purchase products online and/or offline via these payment applications.

Various companies (e.g., credit card companies, financial companies, fintech companies, platform providers, and other entities engaged in financial transactions) are providing payment services via their applications. Consumers can select the payment service to use from among the payment services of various companies according to their own interests and convenience. In addition, consumers may withdraw from the payment service of the company they have previously used, or may newly use the payment service of another company. If consumers who withdraw from a specific payment service are users who frequently made use of that corresponding payment service, and if the number of such users is large, the payment service provider may suffer economic damage. Considering these circumstances, it may be desirable for each company engaged in financial transactions with consumers to more accurately identify, among existing members, the members who are most likely to withdraw so as to engage in prevention measures that discourage withdrawal of the existing members preemptively, and do so based on the analysis of the possibility of user withdrawal and the usage behavior of the user.

### SUMMARY

In order to solve one or more problems (e.g., the problems described above and/or other problems not explicitly described herein), the present disclosure provides a method for, a non-transitory computer-readable recording medium storing instructions for, and a system (apparatus) for predicting membership withdrawal.

As described above, the present disclosure may be implemented in a variety of ways, including a method, a system (apparatus), or a non-transitory computer-readable storage medium storing instructions.

A method for predicting user withdrawal from a payment service is provided, which may be performed by one or more processors and include obtaining, from a memory, member information associated with one or more members, determining, by using a plurality of membership withdrawal prediction machine learning models, a plurality of withdrawal predictions for the one or more members based on the member information associated with the one or more members, and determining a final withdrawal prediction for the one or more members based on the determined plurality of withdrawal predictions.

The determining the plurality of withdrawal predictions may include determining, by using each of the plurality of membership withdrawal prediction machine learning models, a plurality of withdrawal probabilities for the one or more members based on the member information associated with the one or more members, and determining, for each of the one or more members, the plurality of withdrawals based on the determined plurality of withdrawal probabilities.

Each of the plurality of membership withdrawal predictions machine learning models may be trained to output withdrawal probabilities for a plurality of reference members based on reference member information associated with the plurality of reference members.

The plurality of membership withdrawal prediction machine learning models may include at least one ensemble model, and the at least one ensemble model may be trained to determine ensemble withdrawal probabilities for a plurality of reference members, based on a plurality of withdrawal probabilities for a plurality of reference members output from at least some of the plurality of membership withdrawal prediction machine learning models.

The plurality of membership withdrawal prediction machine learning models may include a plurality of membership withdrawal prediction machine learning sub-models for a plurality of member groups, and each of the plurality of membership withdrawal prediction machine learning sub-models is a model trained to determine, based on information on reference member of a plurality of reference members associated with a plurality of reference members belonging to each of the plurality of member groups, a withdrawal probability for each of the plurality of reference members belonging to each of the plurality of member groups, and the plurality of member groups may be generated as a result of grouping the plurality of reference members based on a predetermined criterion.

The determining the final withdrawal prediction of the one or more members may include among the plurality of membership withdrawal prediction machine learning models, if a number of membership withdrawal prediction machine learning models predicting withdrawal for each of the one or more members is equal to or greater than a predefined number, determining the final withdrawal prediction as positive.

The method may further includes receiving, from a computing device, a request for a high-coverage prediction list or a high-accuracy prediction list, adding members determined to have a positive final withdrawal prediction to one of the high-coverage prediction list and the high-accuracy prediction list based on the request, and providing the one of the high-coverage prediction list and the high-accuracy prediction list to the computing device, in which the predefined number may include a predefined number corresponding to the high-coverage prediction list or a predefined number corresponding to the high-accuracy prediction list based on the request, and the predefined number corresponding to the high-coverage prediction list may be less than the predefined number corresponding to the high-accuracy prediction list.

The one or more members may include a plurality of members, and The method may further include receiving, from a computing device, a request to select a member group as a target of the prediction of membership withdrawal, extracting member information associated with one or more members belonging to the selected member group from among a plurality of members, and providing, to the computing device, withdrawal prediction for the one or more members belonging to the member group.

The member information associated with the one or more members may include information on a plurality of items for each of the one or more members, and the method may further include selecting one or more items of the plurality of items to be used as input to at least one of the plurality of membership withdrawal prediction machine learning models, and the determining the plurality of withdrawals may include predicting, by using at least one of the plurality of membership withdrawal prediction machine learning models, withdrawal prediction for at least one of the one or more members based on the information on the selected one or more items.

The member information associated with the one or more members may include information pre-processed in a predetermined manner according to types of a plurality of membership withdrawal prediction machine learning models.

The one or more members may include a plurality of members, and the method may further include associating at least one of the plurality of members who is determined by the final withdrawal prediction to withdraw with one or more contents.

A method for predicting membership withdrawal is provided, which may be performed by one or more processor and include obtaining member information associated with one or more members, determining, by using a plurality of membership withdrawal machine learning prediction models, a plurality of withdrawal probabilities for the one or more members based on the member information associated with the one or more members, and determining, by using an ensemble prediction model, an ensemble withdrawal probability for the one or more members based on the determined plurality of withdrawal probabilities.

The plurality of membership withdrawal prediction machine learning models may include a first machine learning model and a second machine learning model, and determining the plurality of withdrawal probabilities for the one or more members may include outputting, by using the member information associated with the one or more members, a first withdrawal probability from the first machine learning model and a second withdrawal probability from the second machine learning model, and the method may further include determining a final withdrawal prediction for the one or more members based on at least one of the first withdrawal probability, the second withdrawal probability, or the ensemble withdrawal probability.

The determining the final withdrawal prediction may include determining a first withdrawal prediction, a second withdrawal prediction, and an ensemble withdrawal prediction for the one or more members, based on each of the first withdrawal probability, the second withdrawal probability, and the ensemble withdrawal probability, and determining the final withdrawal prediction for the one or more members based on the predicted first withdrawal prediction, second withdrawal prediction, and ensemble withdrawal prediction.

There is provided a non-transitory computer-readable recording medium storing instructions for executing the method described above on a computer.

An information processing system is provided, which may include a memory, and one or more processors connected to the memory and configured to execute one or more computer-readable programs included in the memory, in which the one or more programs may include instructions for obtaining, from the memory, member information associated with one or more members, determining, by using a plurality of membership withdrawal prediction machine learning models, a plurality of withdrawal predictions for the one or more members based on the member information associated with the one or more members, and determining a final withdrawal prediction for the one or more members based on the determined plurality of withdrawal predictions.

The one or more programs may further include instructions for determining, by using each of the plurality of membership withdrawal prediction machine learning models, a plurality of withdrawal probabilities for the one or more members based on the member information on the one or more members, and determining, for each of the one or more members, the plurality of withdrawal predictions based on the determined plurality of withdrawal probabilities.

An information processing system is provided, which may include a memory, and one or more processors connected to the memory and configured to execute one or more computer-readable programs included in the memory, in which the one or more programs may include instructions for obtaining, from the memory, member information associated with one or more members, determining, by using a plurality of membership withdrawal prediction machine learning models, a plurality of withdrawal probabilities for one or more members based on the member information associated with one or more members, and determining, by using an ensemble prediction model, an ensemble withdrawal probability for the one or more members based on the determined plurality of withdrawal probabilities.

The plurality of membership withdrawal prediction models may include a first machine learning model and a second machine learning model, and the one or more programs may further include instructions for outputting, by using the member information associated with the one or more members, a first withdrawal probability from the first machine learning model and a second withdrawal probability from the second machine learning model, and determining a final withdrawal prediction for the one or more members based on at least one of the first withdrawal probability, the second withdrawal probability, or the ensemble withdrawal probability.

The one or more programs may further include instructions for determining a first withdrawal prediction, a second withdrawal prediction, and an ensemble withdrawal prediction for the one or more members, based on each of the first withdrawal probability, the second withdrawal probability, and the ensemble withdrawal probability, and determining the final withdrawal prediction for the one or more members based on the predicted first withdrawal prediction, second withdrawal prediction, and ensemble withdrawal prediction.

According to some examples of the present disclosure, by predicting withdrawal of an existing member using a plurality of membership withdrawal prediction models, accuracy of predicting membership withdrawal can be further improved.

According to some examples of the present disclosure, content targeted for the members expected to withdraw can be provided so as to prevent the withdrawal of existing members. Accordingly, membership withdraw can be effectively prevented while using limited resources.

According to some examples of the present disclosure, withdrawal can be predicted according to a desired type between the high-accuracy prediction and the high-coverage prediction, and accordingly, the range of targeted members for preventing withdrawal can be variously changed according to the status of resources.

According to some examples of the present disclosure, withdrawal can be predicted according to member types such as heavy users, middle users, light users, returning users, and the like, and various contents can be provided for each member type, so that limited resources can be used efficiently.

The effects of the present disclosure are not limited to the effects described above, and other effects not described herein can be clearly understood by those of ordinary skill in the art (hereinafter referred to as “ordinary technician”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 illustrates an example of predicting withdrawal for one or more members;

FIG. 2 schematically illustrates a configuration in which an information processing system is communicatively connected to a plurality of user terminals in order to provide a payment service and/or a membership withdrawal prediction service;

FIG. 3 is a block diagram of an internal configuration of a user terminal and an information processing system;

FIG. 4 illustrates an example of using a membership withdrawal prediction model to determine a withdrawal probability based on member information;

FIG. 5 illustrates an example of using an ensemble model to determine an ensemble withdrawal probability;

FIG. 6 illustrates an example of using reference member information associated with a plurality of reference members belonging to a plurality of member groups to train a plurality of membership withdrawal prediction sub-models;

FIG. 7 illustrates an example of a method for selecting an item to be used as an input to at least one of a plurality of membership withdrawal prediction models;

FIG. 8 illustrates an example of a result of predicting withdrawal for one or more members;

FIG. 9 illustrates an example of a user interface for providing content to a member who is predicted to withdraw;

FIG. 10 is a flowchart provided to explain a method for predicting membership withdrawal; and

FIG. 11 is a flowchart provided to explain a method for predicting membership withdrawal according to another example.

### DETAILED DESCRIPTION

Hereinafter, specific details for the practice of the present disclosure will be described in detail with reference to the accompanying drawings. However, in the following description, detailed descriptions of well-known functions or configurations may be omitted if it makes the subject matter of the present disclosure unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any embodiment.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, if a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

As used in this disclosure, a “member” may include a consumer who is using a specific service (e.g., a payment service, and the like), a consumer who has used it in the past, a consumer who has subscribed to a membership for a specific service, and other individuals having some history of association with a specific service. For example, a “member” may refer to a consumer who has recently used a service for a certain period of time (e.g., within the last 6 months).

As used in this disclosure, “withdrawal” may refer to cancelation of membership for a specific service and/or non-use of that membership within a predetermined period of time (e.g., one month, two months, three months in a row). For example, “membership withdrawal” may mean continuous non-use of a service by an existing member for one month. Accordingly, in the event of continuous non-use of service by the existing member for one month (that is, if the existing member does not use the service for one month continuously), the corresponding member may be determined to have withdrawn. In addition, if it is predicted that the existing member will not use the service continuously for one month from a reference point, the corresponding member may be predicted to withdraw.

As used in this disclosure, “content” may refer to information, data and/or service additionally provided to a user of a specific service (e.g., payment service). The “content” may include optional or additional information, data and/or service provided to a user in order to encourage the use of the specific service, including, for example, promotional content, discount coupon content, free purchase coupon, free gift, but is not limited thereto.

As used in this disclosure, “each of a plurality of A” and/or “respective ones of a plurality of A” may refer to each of all components included in the plurality of A, or may refer to each of some of the components included in the plurality of A. For example, each of a plurality of membership withdrawal prediction models may refer to each of all models included in a plurality of membership withdrawal prediction models or may refer to each of some models included in a plurality of membership withdrawal prediction models.

As used in this disclosure, a “machine learning model” may include any model that uses a machine learning algorithm for inferring an answer to a given input. Machine learning algorithms build a model based on sample data, known as training data, in order to make predictions or decisions without being explicitly programmed to do so. The machine learning model may include an artificial neural network model or a deep learning model including an input layer (layer), a plurality of hidden layers, and an output layer. Although a particular machine learning model is illustrated as a single model, the corresponding machine learning model may include a plurality of models.

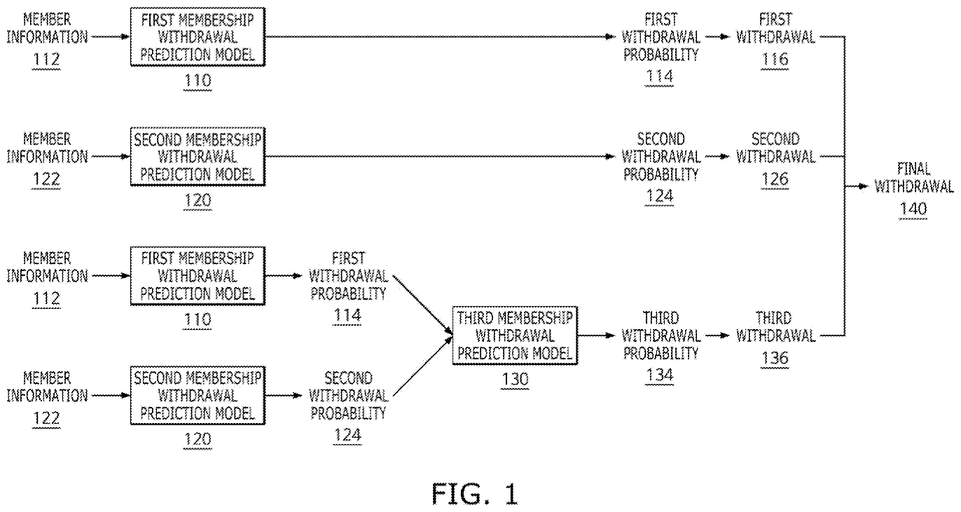

FIG. 1 illustrates an example of predicting a withdrawal 140 for one or more members. An information processing system (not illustrated) may provide a payment service to one or more members. For example, the information processing system may provide a payment service to one or more members via a payment application, website, or other program configured to engage financial transactions. In such a payment service, withdrawal of existing members for a predetermined period (e.g., 1 month, 3 months, 6 months) may lead to longer-term withdrawal or even permanent withdrawal. Therefore, in order to reduce the likelihood of such longer-term/permanent withdrawals, users (e.g., administrators, operators, and/or other individuals associated with the payment service) may want to accurately predict short-term membership withdrawal (e.g., for one month) and take active measures (e.g., provide content such as targeting promotion) to reduce the likelihood of longer-term/permanent withdrawal.

In order to predict membership withdrawal, the information processing system may obtain member information 112 and 122 associated with one or more members. The one or more members may be members who are the target of withdrawal prediction. The members as the target of withdrawal prediction may be limited to members belonging to a specific type or member group. For example, it is possible to group members of a payment service into heavy users, middle users, light users, and other categories based on the amounts of money they used recently (i.e., within a certain period of time), and predict withdrawal of the members belonging to a specific group.

The member information 112 and 122 may include information on a plurality of items. The plurality of items may refer to one or more variables classified into one or more categories, and information on the plurality of items may refer to values for a plurality of items. For example, the one or more categories may include basic membership information, account status, usage trend, balance status, payment trend, charging trend, remittance trend, credit card related information, point level, reward coupon related information, user group statistics, payment related information, sticker-related information, Open Chat (Internet community)-related information, payment trends for each affiliate store, and other categories associated with monetary behavior. Each category may include one or more variables. For example, the one or more variables may include total usage amount, recent usage amount, one-time average usage amount, usage amount according to payment item or type, recent usage time, usage retention period, whether or not there is previous usage withdrawal, whether or not new credit card is issued, the number of associated members, chat frequency, and other factors that affect the associated one or more categories.

As seen in FIG. 1, the information processing system may use a plurality of membership withdrawal prediction models 110, 120, and 130 to predict a plurality of withdrawals 116, 126, and 136 for one or more members based on the member information 112 and 122 associated with the one or more members. For example, the information processing system may use first to third membership withdrawal prediction models 110, 120, and 130 to make a positive or negative prediction of a first withdrawal 116, a second withdrawal 126, and a third withdrawal 136 based on the member information 112 and 122 associated with the one or more members. The first to third membership withdrawal prediction models 110, 120, and 130 may be machine learning models. Items included in the member information 112 and 122, which are used as inputs to each of the membership withdrawal prediction models 110, 120, and 130, may be the same or different from each other depending on models.

The information processing system may use the plurality of membership withdrawal prediction models 110, 120, and 130 to determine the plurality of withdrawal probabilities 114, 124, and 134, and predict the plurality of withdrawals 116, 126, and 136 as either positive or negative from the determined plurality of withdrawal probabilities 114, 124, and 134. For example, the information processing system may use the first to third membership withdrawal prediction models 110, 120, and 130 to determine the first to third withdrawal probabilities 114, 124, and 134. The first to third withdrawals 116, 126, and 136 may be determined according to whether each of the plurality of withdrawal probabilities 114, 124, and 134 is (i) equal to or greater than a predefined threshold (i.e., a positive prediction of withdrawal) or less than the predetermined threshold (i.e., a negative prediction of withdrawal). The predefined threshold for determining withdrawal from the withdrawal probability may be the same or different from each other depending on models.

The plurality of membership withdrawal prediction models 110, 120, and 130 may include a plurality of machine learning models. For example, it may include a Boost-type machine learning model (e.g., XGBoost), a deep learning model (e.g., Fully Connected Neural Network), but is not limited thereto.

A Boost-type machine learning model may incorporate an ensemble meta-algorithm for primarily reducing bias and variance in supervised learning, and a family of machine learning algorithms that convert weak learners to strong ones. A weak learner may be a classifier that is only slightly correlated with the true classification (e.g., it can label examples better than random guessing). A strong learner may be a classifier that is well-correlated with the true classification.

A deep learning model may be based on an Artificial Neural Network and include deep-learning architectures such as deep neural networks, deep belief networks, deep reinforcement learning, recurrent neural networks, convolutional neural networks and Transformers. Deep learning models make use of multiple layers to progressively extract higher-level features from raw input.

Each of the plurality of machine learning models may be a model trained to determine, based on reference member information associated with a plurality of reference members, a withdrawal probability for the reference member. The information processing system may use the trained machine learning model to predict a plurality of withdrawals 116, 126, and 136 of one or more members based on the member information 112 and 122 associated with one or more members.

The plurality of membership withdrawal prediction models 110, 120, and 130 may include at least one ensemble model. The ensemble model may be implemented as a deep learning model including a Fully Connected Neural Network, but is not limited thereto, and it may be any machine learning model trained to receive the withdrawal probabilities for a plurality of reference members determined from a plurality of membership withdrawal prediction models and determine ensemble withdrawal probabilities for a plurality of reference members. The information processing system may use the trained ensemble model predict to predict ensemble withdrawal for one or more members based on a plurality of withdrawal probabilities for one or more members determined from a plurality of membership withdrawal prediction models. For example, FIG. 1 shows the third membership withdrawal prediction model 130 as an example of the ensemble model. The information processing system may use the third membership withdrawal prediction model 130 to determine the third withdrawal probability 134 based on the first and second withdrawal probabilities 114 and 124 for one or more members determined by the first and second membership withdrawal prediction models 110 and 120. The third withdrawal 136 may be determined for one or more members according to whether the third withdrawal probability 134 is equal to or greater than a predefined threshold.

The member information 112 and 122 associated with one or more members input to the membership withdrawal prediction model may include information on a plurality of items. The information processing system may adjust the values of the plurality of items in proportional to the original values in order to adjust the ranges of values for the plurality of items input to the membership withdrawal prediction model to be the same. That is, the member information 112 and 122 associated with one or more members input to the membership withdrawal prediction model may be pre-processed information. The pre-processing method may include, but is not limited to, standardization for transforming values so that values for each item follow a standard distribution, normalization for adjusting distribution so that values for each item have a value between 0 and 1, and other transformations that assist in the evaluation of information. The member information 112 and 122 may be information pre-processed in a predetermined manner according to the type of the input model. The performance of each model is measured using the input data pre-processed in various ways, and the pre-processing method with the best performance according to models is determined, and the input data pre-processed with the method may be used to predict membership withdrawal. For example, if the membership withdrawal prediction model is a Boost-based machine learning model, the input member information may include information pre-processed by performing the standardization of a plurality of items associated with one or more members. As another example, if the membership withdrawal prediction model is a deep learning model, the input member information may include information pre-processed by performing the normalization of a plurality of items associated with one or more members.

The information processing system may integrate the predictions of the plurality of withdrawals 116, 126, and 136 to make a final prediction of withdrawal 140 for one or more members. If the number of membership withdrawal prediction models predicting withdrawal for each member is equal to or greater than a predefined number, a final positive withdrawal prediction (i.e., a final prediction that the member will withdraw) may be made. If the number of membership withdrawal prediction models predicting withdrawal for each member is less than a predefined number, a final negative withdrawal prediction (i.e., a final prediction that the member will not withdraw) may be made. For example, if the predefined number is 2 and if there are two or more models predicting withdrawal for the first member, the information processing system may make a final prediction that the first member would withdraw. Additionally or alternatively, the predefined number may be defined differently according to types of prediction. For example, in a case of a high-accuracy prediction, only if all models predict withdrawal for the first member, would the information processing system make a final prediction that the first member would withdraw. As another example, in a case of a high-coverage prediction, if any one of the plurality of models predicts withdrawal for the first member, would the information processing system make a final prediction that the first member would withdraw.

Additionally or alternatively, the information processing system may determine a plurality of risk levels based on a plurality of withdrawal probabilities 114, 124, and 134 which are determined using a plurality of membership withdrawal prediction models 110, 120, and 130. A final risk level for one or more members may be determined based on the determined plurality of risk levels. The final risk level for the member may be a measure that indicates a degree of predictability that the corresponding member would withdraw. For example, the information processing system may multiply each of the first to third withdrawal probabilities 114, 124, and 134 having a value between 0 and 1 by 1000 to determine first to third risk levels having a value between 0 and 1000. By calculating an average or median value of the determined first to third risk levels, the final risk level for one or more members may be determined. Alternatively, the final risk level may be determined according to a range within which the average or median value of the determined plurality of risk levels falls. For example, the final risk level for one or more members may be classified into high risk level, medium risk level, and low risk level according to the range within which the determined average or median value of first to third risk falls.

The information processing system may provide targeted content based on the final withdrawal prediction, final risk level, and other assessments regarding withdrawal for one or more members. For example, a content (e.g., promotion content and coupon content) for reducing the likelihood membership withdrawal may be provided to a member with a final positive withdraw prediction or a member having a high final risk level.

While FIG. 1 illustrates that each of the plurality of membership withdrawal prediction models 110, 120, and 130 is configured to receive member information and output a withdrawal probability, aspects are not limited thereto, and accordingly, each of the plurality of membership withdrawal prediction models 110, 120, and 130 may be configured to receive member information and output both the withdrawal probability and a reliability of the withdrawal probability. Thus the prediction of withdrawal corresponding to each of a plurality of membership withdrawal prediction models 110, 120, and 130 may be determined in consideration of not only the withdrawal probability but also reliability. For example, if the withdrawal probability of a member is high, but the output reliability of the withdrawal probability is low, it may be predicted that the member would not withdraw.

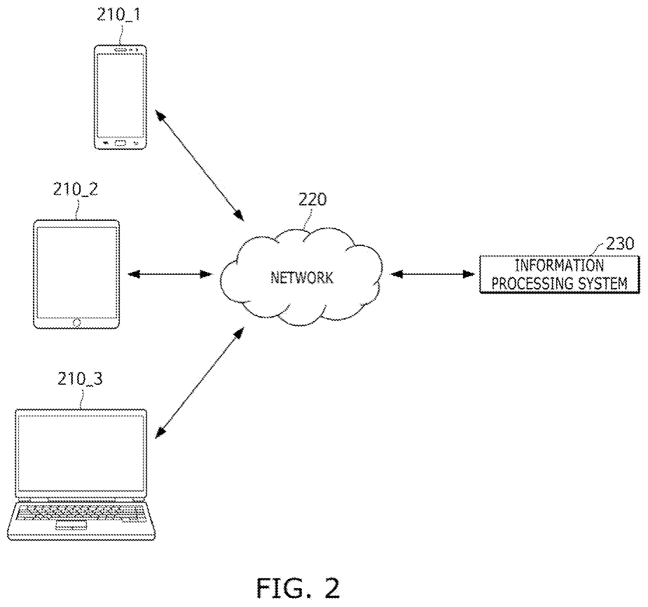

FIG. 2 schematically illustrates a configuration in which an information processing system 230 is communicatively connected to a plurality of user terminals 210_1, 210_2, and 210_3 to provide a payment service and/or a membership withdrawal prediction service. The information processing system 230 may include a system(s) that can provide a payment service and/or a system(s) that can predict membership withdrawal. The information processing system 230 may include one or more server devices and/or databases, or one or more distributed computing devices and/or distributed databases based on cloud computing services, which are capable of storing, providing and executing computer-executable programs (e.g., downloadable applications) and data relating to a payment service, a membership withdrawal prediction service, and/or a content providing service. For example, the information processing system 230 may include separate systems (e.g., servers) for the payment service, the membership withdrawal prediction service, and/or the content providing service. The payment service, the membership withdrawal prediction service, and other services, which are provided by the information processing system 230, may be provided to the user via a payment application, a member management application, web browsers and other computer programs running on each of a plurality of user terminals 210_1, 210_2, and 210_3.

A plurality of user terminals 210_1, 210_2, and 210_3 may communicate with the information processing system 230 through a network 220. The network 220 may be configured to enable communication between a plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, other arrangement for conducting electronic communication, or a combination thereof, depending on the installation environment. The method of communication is not limited, and may include a communication method using a communication network (e.g., mobile communication network, wired Internet, wireless Internet, broadcasting network, satellite network) that may be included in the network 220 as well as short-range wireless communication between the user terminals 210_1, 210_2, and 210_3.

In FIG. 2, a mobile phone terminal 210_1, a tablet terminal 210_2, and a PC terminal 210_3 are illustrated as the examples of the user terminals, but aspects are not limited thereto, and the user terminals 210_1, 210_2 and 210_3 may be any computing device that is capable of wired and/or wireless communication and that can allow a user to interact with the payment service. For example, the user terminal may include a smartphone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and other computing devices. In addition, FIG. 2 illustrates that three user terminals 210_1, 210_2, and 210_3 are in communication with the information processing system 230 through the network 220, but aspects are not limited thereto, and a different number of user terminals may be configured to be in communication with the information processing system 230 through the network 220.

The information processing system 230 may be configured to receive the member information (e.g., payment information, social information, and the like) associated with the member from the user terminals 210_1, 210_2, and 210_3 (e.g., the user terminal of the payment service member). The information processing system 230 may be configured to store the received member information in a storage device such as a database. In another example, the information processing system 230 may receive a prediction type from the user terminals 210_1, 210_2, and 210_3 (e.g., a user terminal such as a payment service manager and/or operator), and provide the result of prediction of membership withdrawal.

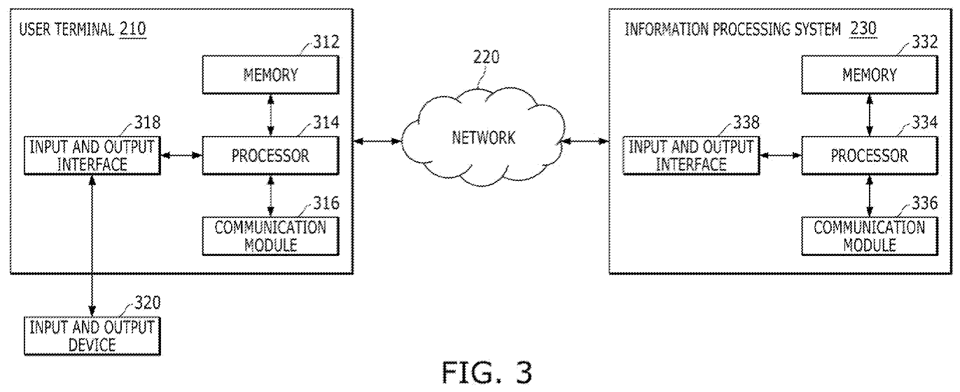

FIG. 3 is a block diagram of an internal configuration of the user terminal 210 and the information processing system 230. The user terminal 210 may refer to any computing device that is capable of executing the payment application, the member management application and so on and also capable of wired/wireless communication, and may include the mobile phone terminal 210_1, the tablet terminal 210_2, and the PC terminal 210_3 of FIG. 2, for example. As illustrated in FIG. 3, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using the respective communication modules 316 and 336. In addition, an input and output device 320 may be configured to input information and/or data to the user terminal 210 or to output information and/or data generated from the user terminal 210 through the input and output interface 318.

The memories 312 and 332 may include any non-transitory computer-readable recording medium. The memories 312 and 332 may include a permanent mass storage device such as random access memory (RAM), read only memory (ROM), disk drive, solid state drive (SSD), and flash memory. As another example, a non-destructive mass storage device such as ROM, SSD, flash memory, disk drive, and so on may be included in the user terminal 210 or the information processing system 230 as a separate permanent storage device that is separate from the memory. In addition, an operating system and at least one program code (e.g., a code for an application associated with a payment service, a membership withdrawal prediction service, and/or a content providing service, and the like) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, and a memory card, for example. As another example, the software components may be loaded into the memories 312 and 332 through the communication modules 316 and 336 rather than the computer-readable recording medium. For example, one or more programs may be loaded into the memories 312 and 332 based on a computer program (e.g., application associated with payment service, membership withdrawal prediction service and/or content providing service, and the like) that is installed by the files provided by the developers or a file distribution system for distributing an installation file of the application through the network 220.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system). For example, a request or data (e.g., a request to predict membership withdrawal) generated by the processor 314 of the user terminal 210 according to the program code stored in the recording device such as the memory 312 may be transmitted to the information processing system 230 through the network 220 under the control of the communication module 316. Conversely, a control signal or a command provided under the control of the processor 334 of the information processing system 230 may be received by the user terminal 210 through the communication module 316 of the user terminal 210 through the communication module 336 and the network 220. For example, the user terminal 210 may receive from the information processing system 230 the result of prediction of membership withdrawal.

The input and output interface 318 may be a means for interfacing with the input and output device 320. As an example, the input device may include a device such as a camera including an audio sensor and/or an image sensor, a keyboard, a microphone, and a mouse, and the output device may include a device such as a display, a speaker, and a haptic feedback device. As another example, the input and output interface 318 may be a means for interfacing with a device such as a touch screen other user interface that integrates a configuration or function for performing inputting and outputting. While FIG. 3 illustrates that the input and output device 320 is not included in the user terminal 210, aspects are not limited thereto, and the input and output device 320 may be configured as one device with the user terminal 210. In addition, the input and output interface 338 of the information processing system 230 may be a means for interfacing with a device (not illustrated) for inputting or outputting that may be connected to, or included in the information processing system 230. While FIG. 3 illustrates the input and output interfaces 318 and 338 as the components configured separately from the processors 314 and 334, aspects are not limited thereto, and the input and output interfaces 318 and 338 may be configured to be included in the processors 314 and 334.

The user terminal 210 and the information processing system 230 may include additional components other than those components illustrated in FIG. 3. The user terminal 210 may be implemented to include at least a part of the input and output device 320 described above. In addition, the user terminal 210 may further include other components such as a transceiver, a Global Positioning System (GPS) module, a camera, various sensors, a database, and the like. For example, if the user terminal 210 is a smartphone, it may generally include components included in a smartphone, and for example, it may be implemented such that various components such as an acceleration sensor, a gyro sensor, a microphone module, a camera module, various physical buttons, buttons using a touch panel, input and output ports, and a vibrator for vibration, are further included in the user terminal 210.

The processor 314 of the user terminal 210 may be configured to operate the payment application, the member management application, and/or the web browser application. A program code associated with the above application may be loaded into the memory 312 of the user terminal 210. While the application is running, the processor 314 of the user terminal 210 may receive information and/or data provided from the input and output device 320 through the input and output interface 318 or receive information and/or data from the information processing system 230 through the communication module 316, and process the received information and/or data and store it in the memory 312. In addition, such information and/or data may be provided to the information processing system 230 through the communication module 316.

While the payment application, the member management application, or other program configured to interact with the payment service are running, the processor 314 may receive voice data, text, image, video, and other data input or selected through the input device such as a camera, and a microphone that includes a touch screen, a keyboard, an audio sensor and/or an image sensor connected to the input and output interface 318, and store the received voice data, text, image, and/or video or the like in the memory 312, or provide it to the information processing system 230 through the communication module 316 and the network 220. The processor 314 of the user terminal 210 may transmit and output the information and/or data to the input and output device 320 through the input and output interface 318. For example, the processor 314 of the user terminal 210 may output the processed information and/or data through the output device 320 such as a device capable of outputting a display (e.g., a touch screen and a display), and a device capable of outputting a voice (e.g., speaker).

The processor 334 of the information processing system 230 may be configured to manage, process, and/or store information and/or data received from a plurality of user terminals 210 and/or a plurality of external systems. The information and/or data processed by the processor 334 may be provided to the user terminals 210 through the communication module 336 and the network 220. The processor 334 of the information processing system 230 may obtain the member information associated with one or more members, and use the plurality of membership withdrawal prediction models to predict the final withdrawal for the one or more members based on the member information associated with the one or more members. The processor 334 may provide the result of prediction of final withdrawal for the one or more members to the user terminal 210 (e.g., a user terminal such as a payment service manager and/or operator).

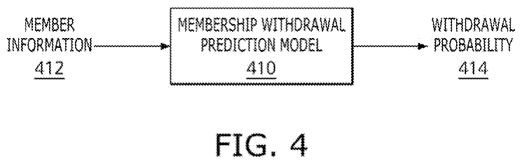

FIG. 4 illustrates an example of using a membership withdrawal prediction model 410 to determine a withdrawal probability 414 based on member information 412. The information processing system (e.g., the information processing system 230) may use a plurality of membership withdrawal prediction models to predict membership withdrawal. The membership withdrawal prediction model 410 may be a machine learning model. For example, it may be a Boost-type machine learning model (e.g., XGBoost), or a deep learning model (e.g., Fully Connected Neural Network), but is not limited thereto.

One membership withdrawal prediction model 410 may be trained to predict the withdrawal probability for a plurality of reference members based on the reference member information associated with the plurality of reference members. The information processing system may obtain, from the member information database, training data for training the membership withdrawal prediction model 410. The member information database may be included in a storage device inside and/or outside the information processing system. In addition, the member information database may include member information associated with a member has who already withdrawn from use and/or a member who retains use. The training data for training the membership withdrawal prediction model 410 may include reference member information associated with a plurality of reference members.

The reference member information associated with a plurality of reference members may include information on a plurality of items. The plurality of items may refer to one or more variables classified into one or more categories, and information on the plurality of items may refer to values for a plurality of items. For example, the one or more categories may include basic membership information, account status, usage trend, balance status, payment trend, charging trend, remittance trend, credit card related information, point level, reward coupon related information, user group statistics, payment related information, sticker-related information, Open Chat (Internet community)-related information, payment trends for each affiliate store, and other categories associated with monetary behavior Each category may include one or more variables. For example, the one or more variables may include total usage amount, recent usage amount, one-time average usage amount, usage amount according to payment item or type, recent usage time, usage retention period, whether or not there is previous usage withdrawal, whether or not new credit card is issued, the number of associated members, chat frequency, and other factors that affect the associated one or more categories.

In addition, the reference member information associated with a plurality of reference members may include information on whether or not a plurality of reference members withdraw (i.e., whether or not the reference members have actually withdrawn). The information processing system may train by supervised learning the membership withdrawal prediction model 410 using the input data of the values for a plurality of items (or values obtained by pre-processing values for plurality of items) described above, and the correct answer data (e.g., correct answer label) of whether or not a plurality of reference members withdraw (e.g., 0 (non-withdrawal) or 1 (withdrawal)). Additionally or alternatively, the information processing system may train the membership withdrawal prediction model 410 based on the information on a plurality of items and the weights of a plurality of items.

The information processing system may input the member information 412 associated with one or more members to the trained membership withdrawal prediction model 410 to determine the withdrawal probability 414 for one or more members. Additionally, the information processing system may predict withdrawal for one or more members based on the withdrawal probability 414 for one or more members determined by the membership withdrawal prediction model 410.

The member information 412 input to the membership withdrawal prediction model 410 may be pre-processed information. The pre-processing method may include, but is not limited to, standardization for transforming values so that values for each item follow a standard distribution, normalization for adjusting distribution so that values for each item have a value between 0 and 1, and other transformations that assist in the evaluation of information. The member information 412 may be information pre-processed in a predetermined manner according to the type of the membership withdrawal prediction model 410. For example, the performance of the predictive model 410 may be measured using the input data pre-processed in various ways, and the pre-processing method having the best performance may be determined, such that the input data pre-processed in the corresponding method may be used.

The information processing system may repeat the processes described above for a plurality of membership withdrawal prediction models, and predict the final withdrawal for one or more members based on a plurality of withdrawals determined by a plurality of membership withdrawal prediction models.

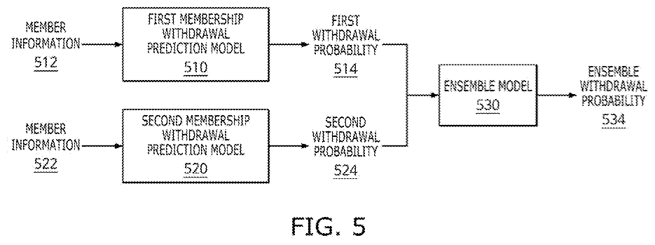

FIG. 5 illustrates an example of determining an ensemble withdrawal probability 534 using an ensemble model 530. The information processing system (e.g., the information processing system 230) may use at least one ensemble model 530 to predict membership withdrawal. The ensemble model 530 may be a machine learning model (e.g., a Fully Connected Neural Network), but is not limited thereto.

The ensemble model 530 may be trained to determine the ensemble withdrawal probabilities for a plurality of reference members based on a plurality of withdrawal probabilities for each of a plurality of reference members predicted by a plurality of membership withdrawal prediction models. For example, the information processing system may train by supervised learning the ensemble model 530 using the input data of a plurality of withdrawal probabilities for each of a plurality of reference members predicted by a plurality of membership withdrawal prediction models, and the correct answer data (e.g., correct answer label) of withdrawals (e.g., 0 (not withdrawal) or 1 (withdrawal)) of a plurality of reference members.

The information processing system may use the trained ensemble model 530 to determine the ensemble withdrawal probability 534 based on a plurality of withdrawal probabilities 514 and 524 for one or more members determined by a plurality of membership withdrawal prediction models. For example, the information processing system may input, to the ensemble model 530, the first withdrawal probability 514 for one or more members determined by a first membership withdrawal prediction model 510 and the second withdrawal probability 524 for one or more members determined by a second membership withdrawal prediction model 520 to determine the ensemble withdrawal probability 534. If the first membership withdrawal prediction model 510 predicts the first withdrawal probability 514 with low accuracy for a specific member, but if the second membership withdrawal prediction model 520 predicts the second withdrawal probability 524 with high accuracy for the corresponding member, the ensemble model 530 may integrate the two withdrawal probabilities 514 and 524, thereby determining the ensemble withdrawal probability 534 with higher accuracy than the first membership withdrawal prediction model 510 for the corresponding member. This method of determination may also be similarly applied if the second membership withdrawal prediction model 520 predicts the second withdrawal probability 524 with low accuracy. In this way, the ensemble model 530 may supplement the two membership withdrawal prediction models 510 and 520. While FIG. 5 illustrates that the ensemble model 530 determines the ensemble withdrawal probability 534 based on the two withdrawal probabilities 514 and 524 determined by the two membership withdrawal prediction models 510 and 520, aspects are not limited thereto, and the ensemble withdrawal probability 534 may be determined based on three or more withdrawal probabilities determined by three or more membership withdrawal prediction models.

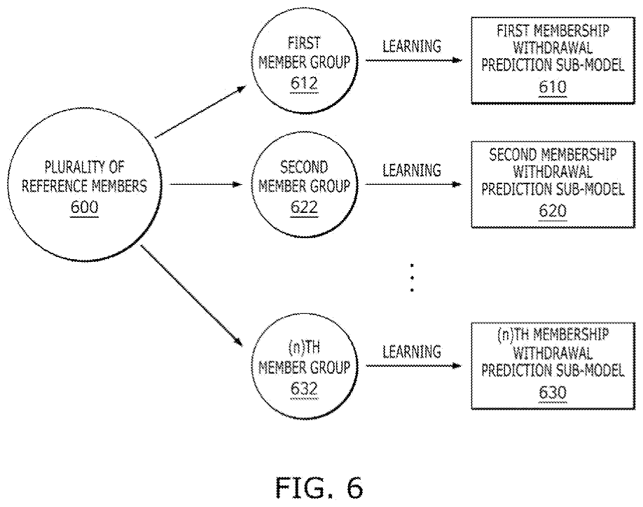

FIG. 6 illustrates an example of using reference member information associated with a plurality of reference members belonging to a plurality of member groups 612, 622, and 632 to train a plurality of membership withdrawal prediction sub-models 610, 620, and 630. The withdrawal prediction sub models 610, 620, and 630 may be machine learning models. The information processing system (e.g., the information processing system 230, and the like) may use a plurality of membership withdrawal prediction models to predict withdrawals of one or more members. The plurality of membership withdrawal prediction models may include a plurality of membership withdrawal prediction sub-models 610, 620, and 630 for a plurality of member groups 612, 622, and 632.

The information processing system may group a plurality of reference members 600 into a plurality of member groups 612, 622, and 632 based on a predetermined criterion. For example, the information processing system may group a plurality of reference members 600 into a heavy user group, a middle user group, a light user group, and other categories based on the total payment amount for the last six months.

The information processing system may train each of a plurality of membership withdrawal prediction sub-models 610, 620, and 630 based on reference member information associated with a plurality of reference members included in each of a plurality of member groups 612, 622, and 632. That is, the information processing system may train the first membership withdrawal prediction sub-model 610 based on the reference member information associated with the reference member included in the first member group 612 of a plurality of reference members 600, and train the second membership withdrawal prediction sub-model 620 based on the reference member information associated with the reference member included in the second member group 622. In a manner similar to that described above, the information processing system may train the (n)th membership withdrawal prediction sub-model 630 based on reference member information associated with a reference member included in the (n)th member group 632. Each member group may have different member withdrawal rates, and in each member group, the member information items (category or variable, and the like) having a high correlation with the withdrawal may be different. Accordingly, the information processing system may improve the performance of the membership withdrawal prediction model by training the membership withdrawal prediction sub-model for each member group.

While FIG. 6 illustrates that there is one membership withdrawal prediction sub-model for one member group, aspects are not limited thereto. In some examples, there may be a plurality of membership withdrawal prediction sub-models for one member group, and the plurality of membership withdrawal prediction sub-models may be trained based on the reference member information associated with the reference member included in one member group. For example, based on the reference member information associated with the reference member included in the first member group 612, a plurality of membership withdrawal prediction sub-models may be trained.

The plurality of membership withdrawal prediction sub-models 610, 620, and 630 for a plurality of member groups 612, 622, and 632 may be used for the prediction of withdrawal probability and/or the prediction of withdrawal for members belonging to each member group. The information processing system may group a plurality of members as the target of withdrawal prediction into a plurality of member groups 612, 622, and 632, based on the same or similar criteria as the criteria for grouping a plurality of reference members 600. The information processing system may use a plurality of membership withdrawal prediction sub-models for the member group to which the member as the target of the withdrawal prediction belongs, to predict the withdrawal probability or withdrawal of the target member. For example, the withdrawal probability or withdrawal of the target member belonging to the first member group 612 may be predicted by using a plurality of membership withdrawal prediction sub-models trained based on reference member information associated with a reference member belonging to the first member group 612. By using the membership withdrawal prediction sub-model trained based on the member information of the members in the same group as the target member, the information processing system may more accurately predict withdrawal of the target member.

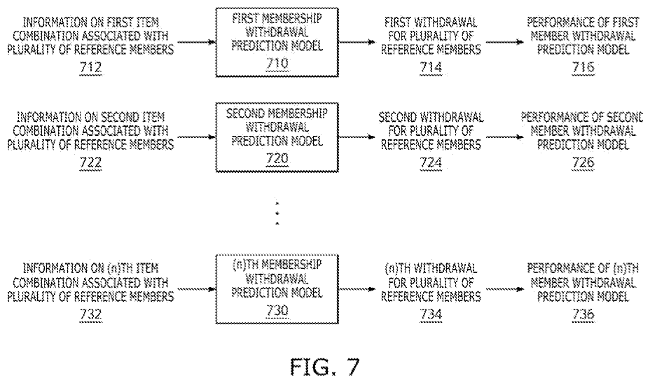

FIG. 7 illustrates an example of a method for selecting an item to be used as an input to at least one of a plurality of membership withdrawal prediction models. The member information associated with one or more members may include information on a plurality of items. The plurality of items may refer to one or more variables classified into one or more categories, and information on the plurality of items may refer to values for a plurality of items. For example, the one or more categories may include basic membership information, account status, usage trend, balance status, payment trend, charging trend, remittance trend, credit card related information, point level, reward coupon related information, user group statistics, payment related information, sticker-related information, Open Chat (Internet community)-related information, payment trends for each affiliate store, and other categories associated with monetary behavior. Each category may include one or more variables. For example, the one or more variables may include total usage amount, recent usage amount, one-time average usage amount, usage amount according to payment item or type, recent usage time, usage retention period, whether or not there is previous usage withdrawal, whether or not new credit card is issued, the number of associated members, chat frequency, and other factors that affect the associated one or more categories.

The information processing system may select one or more items to be used as at least one input, from among a plurality of membership withdrawal prediction models. For example, the information processing system may analyze the reference member information associated with a plurality of reference members, and select one or more items having a correlation with whether or not the reference member would withdraw. As a specific example, the information processing system may analyze the reference member information associated with a plurality of reference members to determine that the items such as the number of consecutive months of use, a payment method with the characteristics of a one-time high-value transaction, or the proportion of payment items, have a high correlation with withdrawal, and include at least one of the corresponding items in the input items of the membership withdrawal prediction model.

As another example, the information processing system may generate a plurality of item combinations, and select, as the input item combination, an one of a plurality of item combinations that has the best performance of the membership withdrawal prediction model. As a specific example, as illustrated in FIG. 7, the information processing system may generate first to (n)th item combinations from a plurality of items.

By using each of information 712 on the first item combination, information 722 on the second item combination, . . . , information 732 on the (n)th item combination associated with a plurality of reference members, each of a first membership withdrawal prediction model 710, a second membership withdrawal prediction model 720, . . . , an (n)th membership withdrawal prediction models 730 may be trained. While FIG. 7 illustrates that each of the first to (n)th membership withdrawal prediction models 710, 720, and 730 is illustrated as one model, aspects are not limited thereto, and each of the first to (n)th membership withdrawal prediction models 710, 720, and 730 may include a plurality of membership withdrawal prediction models. For example, the (k)th membership withdrawal prediction model include a (k-a)th membership withdrawal prediction model (e.g., a machine learning model of the Boost series), a (k-b)th membership withdrawal prediction model (e.g., a fully connected neural network), and a (k-c)th membership withdrawal prediction model (e.g., an ensemble model). The information processing system may train all of a plurality of models included in the (k)th membership withdrawal prediction model by using the information on the (k)th item combination associated with a plurality of reference members.

The information processing system may measure performances 716, 726, and 736 of a plurality of membership withdrawal prediction models 710, 720 and 730, and select a combination of items with the best performance as an input item. For example, by using a plurality of withdrawals 714, 724, and 734 (or a plurality of withdrawal probabilities) for a plurality of reference members predicted by a plurality of membership withdrawal prediction models 710, 720, and 730 (each membership withdrawal prediction model may include a plurality of models), and actual withdrawals of a plurality of reference members, the performance 716, 726, and 736 of a plurality of membership withdrawal prediction models 710, 720, and 730 may be measured. As a result of the performance measurement, if the performance of the (k)th membership withdrawal prediction model is the best, the (k)th item combination may be selected as an input item.

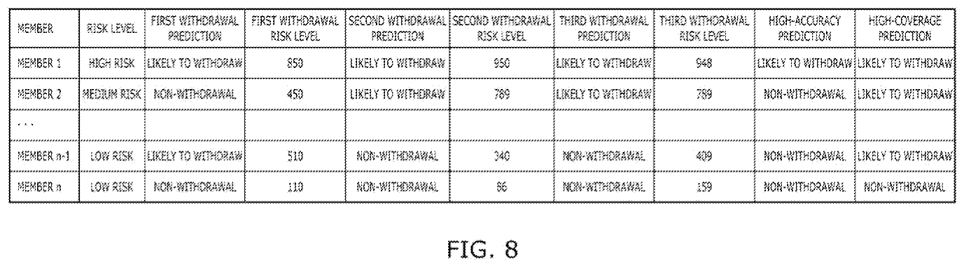

FIG. 8 illustrates an example of a prediction withdrawal result of one or more members. According to the illustrated table, the information processing system (e.g., the information processing system 230) may provide a risk level, a plurality of withdrawal predictions, a plurality of withdrawal risk levels, high-accuracy predictions, and high-coverage predictions for one or more members (“Member 1”, “Member 2”, . . . , “Member n−1”, “Member n’).

As seen in FIG. 8, each of a plurality of withdrawal risk levels may be a measure that indicates the degree with which the target member is predicted to withdraw, which is determined by each of a plurality of membership withdrawal prediction models. A plurality of withdrawal risk levels may be determined based on a plurality of withdrawal probabilities determined by a plurality of membership withdrawal prediction models. For example, the information processing system may determine a plurality of withdrawal risk levels by multiplying a plurality of withdrawal probabilities determined by a plurality of membership withdrawal prediction models by 1000. As a specific example, if the first membership withdrawal prediction model predicts the withdrawal probability for “member 1” to be “0.85”, the first withdrawal risk level for “member 1” may be determined to be “850”.

As seen in FIG. 8, each of a plurality of withdrawals predictions may indicate the withdrawal predicted by each of a plurality of membership withdrawal prediction models. A plurality of withdrawal predictions may be determined based on a plurality of withdrawal probabilities determined by a plurality of membership withdrawal prediction models. For example, if the withdrawal probability determined by the membership withdrawal prediction model is 0.5 or more, the information processing system may predict withdrawal to be “likely to withdraw”, and if the determined withdrawal probability is less than 0.5, the information processing system may predict withdrawal to be “non-withdrawal”. As a specific example, if the first membership withdrawal prediction model predicts the withdrawal probability for “member 1” to be “0.85”, the first withdrawal prediction for the first member may be “likely to withdraw”.

As seen in FIG. 8, the risk level may be a measure that indicates the degree with which the target member is predicted to finally withdraw, which is determined by integrating a plurality of risk levels. For example, the information processing system may calculate an average (or median) value of a plurality of risk levels. The information processing system may determine the risk level for the member based on the calculated average (or median) value, the range within which the calculated average (or median) value falls, the rank of the calculated average (or median) value, or the like. As a specific example, if the average value of the first withdrawal risk level “850”, the second withdrawal risk level “950”, and the third withdrawal risk level “948” for “Member 1” is calculated, and the corresponding average value falls within the top k % of the (n) number of target members, the risk level for “member 1” may be determined to be “high risk”.

As seen in FIG. 8, the high-accuracy prediction and high-coverage prediction may indicate final withdrawal for the members, which are predicted by integrating the withdrawals predicted by each of a plurality of membership withdrawal prediction models. For example, if the number of models that predicted the target member to be “likely to withdraw” is equal to or greater than a predefined number, the target member may be predicted to be “likely to withdraw” and if the number of models that predicted the target member to be “likely to withdraw” is less than the predefined number, the target member may be finally predicted to be “non-withdrawal”. The predefined number corresponding to a high-accuracy prediction may be greater than the predefined number corresponding to a high-coverage prediction. That is, in the case of the high-accuracy prediction, if a large number of membership withdrawal prediction models predict the target member to be “likely to withdraw”, the target member is finally predicted to be “likely to withdraw”, thereby increasing the accuracy of prediction. In addition, in the case of the high-coverage prediction, if a relatively small number of membership withdrawal prediction models predict the target member to be “likely to withdraw”, the target member is finally predicted to be “likely to withdraw”, thereby improving the coverage of the prediction.

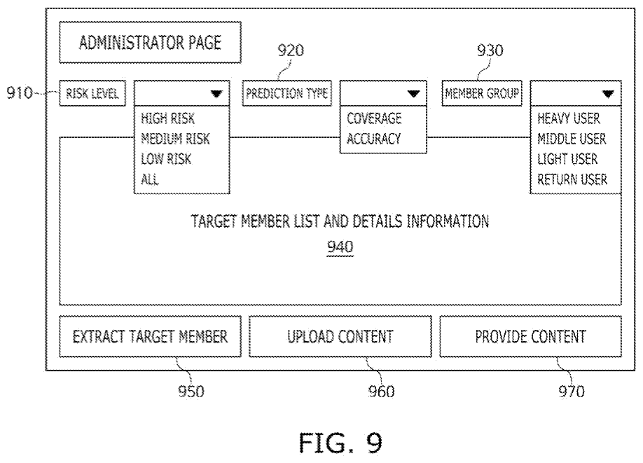

FIG. 9 illustrates an example of a user interface for providing content to a member who is predicted to withdraw. The user interface for outputting a list of members who have a final prediction of withdrawal, and providing a content to the corresponding members may be provided. A user terminal (or computing device) provided with the user interface may be a terminal (or device) of an administrator or operator.

The user interface may include a risk level selection menu 910, a prediction type selection menu 920, a member group selection menu 930, a target member list and details output area 940, a target member extraction button 950, a content upload button 960, and a content provide button 970. In the risk level selection menu 910 and the member group selection menu 930, a plurality of items may be selected. For example, if the user selects or limits at least one of risk level, prediction type, or member group, and clicks or touches the target member extraction button 950, a content providing target member list and details may be output in the target member list and details output area 940.

The user may limit the risk level of the content providing target member in the risk level selection menu 910. While FIG. 9 illustrates the risk level classified into high risk, medium risk, and low risk, aspects are not limited thereto. For example, the risk level may refer to a scale indicating the degree to which a member is predicted to withdraw as a value between 0 and 1000, and the user can select or directly input the range of the risk level of the member to be provided with content through the user interface.

The user may select a membership withdrawal prediction type from the prediction type selection menu 920. For example, the user may select one of a high-coverage prediction (i.e., a sensitive prediction) or a high-accuracy prediction (i.e., a specific prediction). If the user selects the high-coverage prediction, members predicted to withdraw by at least one of a plurality of membership withdrawal prediction models may be the member targeted to be provided with the content. If the user selects the high-accuracy prediction, members predicted to withdraw by all of a plurality of membership withdrawal prediction models may be the member targeted to be provided with the content.

The user may limit the group of the content providing target member in the member group selection menu 930. FIG. 9 illustrates that heavy user, middle user, light user, and return user as examples of member groups, aspects are not limited thereto, and various member groups grouped by various criteria may be included in the list. If there is a membership withdrawal prediction sub-model for a member group selected by a user, prediction of withdrawal for members included in the selected member group may be performed using the corresponding sub-model.

The user may select or limit at least some of the risk level, the prediction type, or the member group. For example, if the user selects high risk from the risk level selection menu 910, selects the heavy user from the member group selection menu 930, and does not select the prediction type, among the members included in the heavy user group, members with the high risk level of withdrawal may be members targeted to be provided with the content. As another example, if the user selects the high-accuracy prediction from the prediction type selection menu 920 and does not select the other menus, any of the members that are predicted to withdraw by all of a plurality of membership withdrawal prediction models may be members targeted to be provided with the content.

After extracting target members, the user may touch or click the content upload button 960 to upload content to be provided to the extracted target members. For example, if the content upload button 960 is touched or clicked, a list of contents may be output, and the user may select and upload one from the list. The user may add new content to the list of contents, change the content of the existing content, or delete the existing content.

After uploading the content, the user may touch or click the content provide button 970 to provide the uploaded content to the extracted target members. As described above, the user may select or limit the risk level, prediction type, member group, and any other selection to perform withdrawal prediction according to a desired method, and use this to provide a targeting content to some members, thereby efficiently using limited resources.

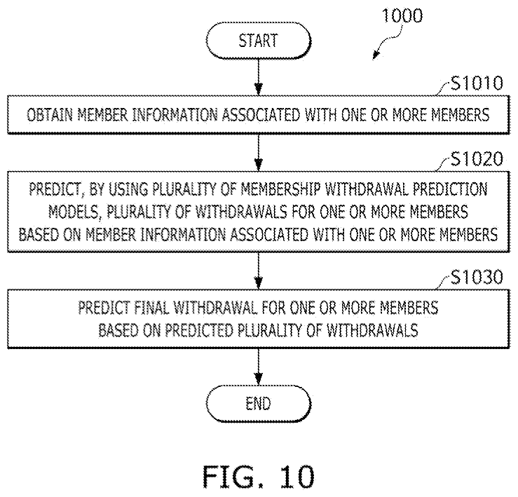

FIG. 10 is a flowchart provided to explain a method 1000 for predicting membership withdrawal. The method 1000 for predicting membership withdrawal may be performed by a processor (e.g., at least one processor 334 of the information processing system 230). The method 1000 for predicting membership withdrawal may be initiated by the processor obtaining member information associated with one or more members, at step S1010. The member information may include information on a plurality of items associated with the member.

The processor may use a plurality of membership withdrawal prediction models to predict a plurality of withdrawals for the one or more members based on the member information associated with the one or more members, at step S1020. The withdrawal of a member may herein refer to the corresponding member not using the service for a predetermined period (e.g., one month). In order to predict a plurality of withdrawals of one or more members, the processor may use a plurality of membership withdrawal prediction models to determine a plurality of withdrawal probabilities for one or more members based on the member information associated with one or more members, and determine a plurality of withdrawals based on the determined plurality of withdrawal probabilities. For example, a plurality of withdrawals for one or more members may be determined according to whether or not each of a plurality of withdrawal probabilities for one or more members determined by a plurality of membership withdrawal prediction models is equal to or greater than a predefined threshold.

member information associated with one or more members input to a plurality of membership withdrawal prediction models may include information pre-processed in a predetermined manner according to the type of membership withdrawal prediction model. For example, for each of a plurality of models, among various pre-processing methods, a pre-processing method having the best performance of the model may be determined, and the data pre-processed in the corresponding method may be used as an input.

The processor may select any of a plurality of member information items to be used as an input to at least one of a plurality of membership withdrawal prediction models. The processor may use at least one of a plurality of membership withdrawal prediction models to predict at least one withdrawal for one or more members based on the information on the selected item.

A plurality of membership withdrawal prediction models may include a plurality of machine learning models. The machine learning model may be a model trained to determine the withdrawal probabilities of a plurality of reference members based on reference member information associated with a plurality of reference members. Additionally, a plurality of membership withdrawal prediction models may include at least one ensemble model. The ensemble model may be a model trained to determine ensemble withdrawal probabilities for a plurality of reference members based on a plurality of withdrawal probabilities for a plurality of reference members output from a plurality of membership withdrawal prediction models.

Additionally or alternatively, a plurality of membership withdrawal prediction models may include a plurality of membership withdrawal prediction sub-models for a plurality of member groups. The plurality of membership withdrawal prediction sub-models may include a plurality of machine learning models. A plurality of member groups may be a group generated as a result of grouping the plurality of reference members based on a predetermined criterion. Each of a plurality of membership withdrawal prediction sub-models may correspond to a model trained based on reference member information associated with a plurality of reference members included in each of a plurality of member groups. The processor may determine any of a plurality of member groups that includes the target member, based on the obtained member information associated with the member who is the target of the withdrawal prediction, and predict the withdrawal probability and/or withdrawal of the target member by using the membership withdrawal prediction sub-models for the member group including the target member.

The processor may make a final withdrawal prediction of one or more members based on the predicted plurality of withdrawals, at step S1030. For example, if the number of membership withdrawal prediction models that predicted withdrawal for each of the one or more members is equal to or greater than a predefined number, the processor may finally predict that each of the one or more members would withdraw.

Additionally, the processor may associate the members predicted for the final withdrawal with the one or more contents. For example, a user interface capable of providing the contents to the targeted members may be provided. The user (e.g., administrators, operators) may select a prediction type (e.g., high-coverage prediction or high-accuracy prediction) through the corresponding user interface or limit the content providing target member group (e.g., heavy user, middle user, light user). The information processing system may predict the withdrawals according to the prediction type selected by the user with respect to the members included in the member group limited by the user, and provide a list of members targeted to be provided with the content. In addition, in response to a user's request to provide the content, the requested content may be provided to the members targeted to be provided with the content.

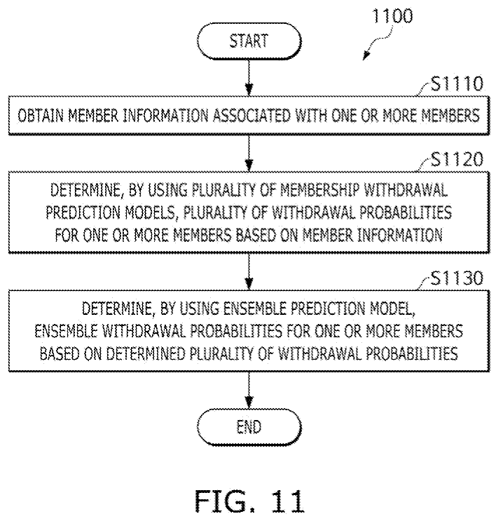

FIG. 11 is a flowchart provided to explain a method for predicting membership withdrawal according to another example. The method 1100 for predicting membership withdrawal may be performed by a processor (e.g., at least one processor 334 of the information processing system 230). The method 1100 for predicting membership withdrawal may be initiated by the processor obtaining member information associated with one or more members, at step S1110.

The processor may use a plurality of membership withdrawal prediction models to determine a plurality of withdrawal probabilities for the one or more members based on member information associated with the one or more members, at step S1120. A plurality of membership withdrawal prediction models may include a first machine learning model and a second machine learning model. The processor may use the information associated with one or more members to output a first withdrawal probability from the first machine learning model and output a second withdrawal probability from the second machine learning model.

The processor may use the ensemble prediction model to determine ensemble withdrawal probabilities for one or more members based on the determined plurality of withdrawal probabilities, at step S1130. Based on at least one of the first withdrawal probability, the second withdrawal probability, and the ensemble withdrawal probability, the final withdrawal for one or more members may be predicted. The processor may predict a first withdrawal, a second withdrawal, and an ensemble withdrawal for the one or more members based on each of the first withdrawal probability, the second withdrawal probability, and the ensemble withdrawal probability. The processor may predict the final withdrawal for the one or more members based on the predicted first withdrawal, second withdrawal, and ensemble withdrawal.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies according to design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for predicting user withdrawal from a payment service, the method being performed by one or more processors and comprising:
obtaining, from a memory, member information associated with one or more members;
determining, by using a plurality of membership withdrawal prediction machine learning models, a plurality of withdrawal predictions for the one or more members based on the member information associated with the one or more members; and
determining a final withdrawal prediction for the one or more members based on the determined plurality of withdrawal predictions.

2. The method according to claim 1, wherein the determining the plurality of withdrawal predictions includes:
determining, by using each of the plurality of membership withdrawal prediction machine learning models, a plurality of withdrawal probabilities for the one or more members based on the member information associated with the one or more members; and
determining, for each of the one or more members, the plurality of withdrawal predictions based on the determined plurality of withdrawal probabilities.

3. The method according to claim 1, wherein:
each of the plurality of membership withdrawal prediction machine learning models is trained to output withdrawal probabilities for a plurality of reference members based on reference member information associated with the plurality of reference members.

4. The method according to claim 1, wherein the plurality of membership withdrawal prediction machine learning models include at least one ensemble model, and
the at least one ensemble model is trained to determine ensemble withdrawal probabilities for a plurality of reference members, based on a plurality of withdrawal probabilities for a plurality of reference members output from at least some of the plurality of membership withdrawal prediction machine learning models.

5. The method according to claim 1, wherein:
the plurality of membership withdrawal prediction machine learning models include a plurality of membership withdrawal prediction machine learning sub-models for a plurality of member groups;
each of the plurality of membership withdrawal prediction machine learning sub-models is a model trained to determine, based on information on reference member of a plurality of reference members associated with a plurality of reference members belonging to each of the plurality of member groups, a withdrawal probability for each of the plurality of reference members belonging to each of the plurality of member groups; and
the plurality of member groups are generated as a result of grouping the plurality of reference members based on a predetermined criterion.

6. The method according to claim 1, wherein the determining the final withdrawal prediction of the one or more members includes, among the plurality of membership withdrawal prediction machine learning models, if a number of membership withdrawal prediction machine learning models predicting withdrawal for each of the one or more members is equal to or greater than a predefined number, determining the final withdrawal prediction as positive.

7. The method according to claim 6, wherein the method further includes:
receiving, from a computing device, a request for a high-coverage prediction list or a high-accuracy prediction list;
adding members determined to have a positive final withdrawal prediction to one of the high-coverage prediction list and the high-accuracy prediction list based on the request; and
providing the one of the high-coverage prediction list and the high-accuracy prediction list to the computing device, wherein
the predefined number includes:
a predefined number corresponding to the high-coverage prediction list, or a predefined number corresponding to the high-accuracy prediction list based on the request; and
wherein the predefined number corresponding to the high-coverage prediction list is less than the predefined number corresponding to the high-accuracy prediction list.

8. The method according to claim 1, wherein the one or more members include a plurality of members, and
the method further includes:
receiving, from a computing device, a request to select a member group as a target of the prediction of membership withdrawal;
extracting member information associated with one or more members belonging to the selected member group from among a plurality of members; and
providing, to the computing device, withdrawal prediction for one or more members belonging to the member group.

9. The method according to claim 1, wherein:
the member information associated with the one or more members includes information on a plurality of items for each of the one or more members;
the method further includes selecting one or more items of the plurality of items to be used as input to at least one of the plurality of membership withdrawal prediction machine learning models; and
the determining the plurality of withdrawal predictions includes determining, by using at least one of the plurality of membership withdrawal prediction machine learning models, withdrawal prediction for at least one of the one or more members based on the information on the selected one or more items.

10. The method according to claim 1, wherein the member information associated with the one or more members includes information pre-processed in a predetermined manner according to types of the plurality of membership withdrawal prediction machine learning models.

11. The method according to claim 1, wherein:
the one or more members include a plurality of members; and
the method further includes associating at least one of the plurality of members who is determined by the final withdrawal prediction to withdraw with one or more contents.

12. A method for predicting membership withdrawal, the method being performed by one or more processors and comprising:
obtaining, from a memory, member information associated with one or more members;
determining, by using a plurality of membership withdrawal prediction machine learning models, a plurality of withdrawal probabilities for the one or more members based on the member information associated with the one or more members; and
determining, by using an ensemble prediction model, an ensemble withdrawal probability for the one or more members based on the determined plurality of withdrawal probabilities.

13. The method according to claim 12, wherein:
the plurality of membership withdrawal prediction machine learning models include a first machine learning model and a second machine learning model;
the determining the plurality of withdrawal probabilities for the one or more members includes outputting, by using the member information associated with the one or more members, a first withdrawal probability from the first machine learning model and a second withdrawal probability from the second machine learning model; and
the method further includes determining a final withdrawal prediction for the one or more members based on at least one of the first withdrawal probability, the second withdrawal probability, or the ensemble withdrawal probability.

14. The method according to claim 13, wherein the determining the final withdrawal prediction includes:
determining a first withdrawal prediction, a second withdrawal prediction, and an ensemble withdrawal prediction for the one or more members, based on each of the first withdrawal probability, the second withdrawal probability, and the ensemble withdrawal probability; and
determining the final withdrawal prediction for the one or more members based on the predicted first withdrawal prediction, second withdrawal prediction, and ensemble withdrawal prediction.

15. A non-transitory computer-readable recording medium storing instructions that, when executed by one or more processors, cause performance of the method comprising:
obtaining, from a memory, member information associated with one or more members;
determining, by using a plurality of membership withdrawal prediction machine learning models, a plurality of withdrawal predictions for the one or more members based on the member information associated with the one or more members; and
determining a final withdrawal prediction for the one or more members based on the determined plurality of withdrawal predictions.

16. An information processing system comprising:
a memory; and
one or more processors connected to the memory and configured to execute one or more computer-readable programs included in the memory,
wherein the one or more programs include instructions for:
obtaining, from the memory, member information associated with one or more members;
determining, by using a plurality of membership withdrawal prediction machine learning models, a plurality of withdrawal predictions for the one or more members based on the member information associated with the one or more members; and
determining a final withdrawal prediction for the one or more members based on the determined plurality of withdrawal predictions.

17. The information processing system according to claim 16, wherein the one or more programs further include instructions for:
determining, by using each of the plurality of membership withdrawal prediction machine learning models, a plurality of withdrawal probabilities for the one or more members based on the member information on the one or more members; and
determining, for each of the one or more members, the plurality of withdrawal predictions based on the determined plurality of withdrawal probabilities.

18. An information processing system comprising:
a memory; and
one or more processors connected to the memory and configured to execute one or more computer-readable programs included in the memory,
wherein the one or more programs include instructions for:
obtaining, from the memory, member information associated with one or more members;
determining, by using a plurality of membership withdrawal prediction machine learning models, a plurality of withdrawal probabilities for the one or more members based on the member information associated with the one or more; and
determining, by using an ensemble prediction model, an ensemble withdrawal probability for the one or more members based on the determined plurality of withdrawal probabilities.

19. The information processing system according to claim 18, wherein the plurality of membership withdrawal prediction machine learning models include a first machine learning model and a second machine learning model;
the one or more programs further include instructions for:
outputting, by using the member information associated with the one or more members, a first withdrawal probability from the first machine learning model and a second withdrawal probability from the second machine learning model; and
determining a final withdrawal prediction for the one or more members based on at least one of the first withdrawal probability, the second withdrawal probability, or the ensemble withdrawal probability.

20. The information processing system according to claim 19, wherein the one or more programs further include instructions for:
determining a first withdrawal prediction, a second withdrawal prediction, and an ensemble withdrawal prediction for the one or more members, based on each of the first withdrawal probability, the second withdrawal probability, and the ensemble withdrawal probability; and
determining the final withdrawal prediction for the one or more members based on the predicted first withdrawal prediction, second withdrawal prediction, and ensemble withdrawal prediction.
